(19) United States
(12) Patent Application Publication
(10) Pub. No.: US 2009/0217747 A1
(43) Pub. Date: Sep. 3, 2009

(54) Single Car Trainline Tester

(75) Inventors: Brian Gallagher, Watertown, NY (US); Anthony Lumbis, Watertown, NY (US)

Correspondence Address: BARNES & THORNBURG LLP, 750-17TH STREET NW, SUITE 900, WASHINGTON, DC, 20006-4675, US

(73) Assignee: New York Air Brake, Watertown, NY (US)

(21) Appl. No.: 12/039,271

(22) Filed: Feb. 28, 2008

(51) Int. Cl. G01L 5/28

(52) U.S. Cl. 73/121

(57) ABSTRACT

A test device includes a trainline connector for connecting the test device to a car trainline to which the electropneumatic brake device is connected and includes a power port to receive power for the trainline at a first voltage. A power switch selectively connects the power port to the trainline connector. A test switch selectively connects a test voltage smaller than the first voltage to the trainline connector. A sensor senses an electrical parameter of the trainline. A controller a) initially controls the power switch to disconnect the power port from the trainline connector, b) subsequently controls the test switch to connect the test voltage to the trainline connector and c) if the sensor senses an electrical parameter indicative of an acceptable trainline, controls the test switch to disconnect the test voltage from the trainline connector and controlling the power switch to connect the power port to the trainline connector.

### BACKGROUND AND SUMMARY OF THE DISCLOSURE

The present invention relates generally to electrically controlled pneumatic (ECP) brake systems on trains and, more specifically, to a test device for ECP brake device on a car.

Electrically controlled pneumatic brake systems on trains have a head end controller which is connected to a trainline to transmit power and control signals to electro pneumatic brake devices on each of the cars. The head and trainline controller may include software for testing a signal quality on a trainline network. Such a device is described in U.S. Pat. No. 6,759,971. Signals transmitted down the trainline commands each node to transmit a calibration signal. The signal quality is determined based on the receipt of the calibration signal.

The method for preventing shock or powering of an electric trainline in an ECP brake system until a test system transmitted through the trainline is verified by the locomotive is described in U.S. Pat. No. 5,673,876. The test signal is at a lower voltage than the power signal that is normally applied to the trainline. Whether there is a safe transmission, is determined by a device at the other end of the trainline.

A method of setting ECP brakes to modes of operation in small groups of cars is described in U.S. Pat. No. 6,979,061. A wake-up signal-voltage less than the regular train voltage is applied and the communication to the each of the devices on the individual cars is established.

A single car tester for ECP equipped cars are presently available. These testers do not include testing of the integrity of the trainline within the individual car. The present test device provides a test for the trainline integrity of the individual cars.

The present test device for an electro pneumatic brake device on a rail car includes a trainline connector for connecting the test device to a car trainline to which the electro pneumatic brake device is connected and includes a power port to receive power for the trainline at a first voltage. A power switch selectively connects the power port to the trainline connector. A test switch selectively connects a test voltage smaller than the first voltage to the trainline connector. A sensor senses an electrical parameter of the trainline. A controller a) initially controls the power switch to disconnect the power port from the trainline connector, b) subsequently controls the test switch to connect the test voltage to the trainline connector and c) if the sensor senses an electrical parameter indicative of an acceptable trainline, controls the test switch to disconnect the test voltage from the trainline connector and controlling the power switch to connect the power port to the trainline connector.

The trainline includes two conductors and the test switches includes two conductor test switches each selectively connects a respective conductor to one of the test voltage and ground, as controlled by the controller. The test switch includes a ground test switch selectively connecting a ground port to one of the test voltage and ground, as controlled by the controller. The sensor senses the electrical parameter of each conductor and of the ground port.

The sensor senses current in the trainline. The controller determines an acceptable trainline if the sensed current is indicative of an impedance above a threshold.

The power switch includes a first and second test switches. The first test switch selectively connects the power port to the second test switch when closed; and the second power switch selectively connects one of the test switch and the first power switch to the trainline connector. The controller opens the first power switch before connecting the test switch to the trainline connector using the second power switch.

The controller conducts a test of the electropneumatic brake device after controlling the power switch to connect the power port to the trainline connector for an acceptable trainline. For an unacceptable trainline, the controller controls the power switch to connect the power port to the trainline connector after an acknowledgement from the operator.

These and other aspects of the present disclosure will become apparent from the following detailed description of the disclosure, when considered in conjunction with accompanying drawings.

### BRIEF DESCRIPTION OF THE DRAWINGS

FIG. 1 is a block diagram of a single car tester for an ECP brake according to the principles of the present disclosure.

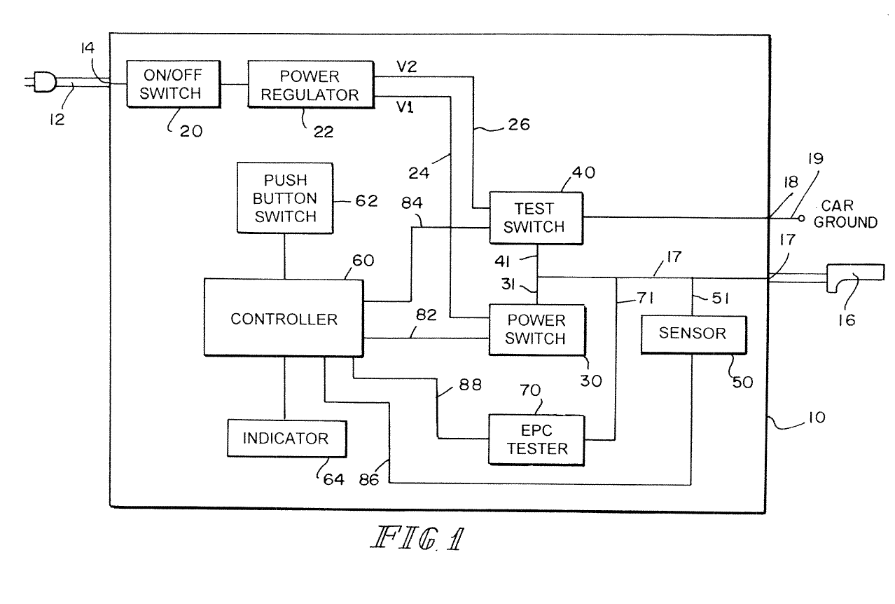

FIG. 2 is a schematic of the trainline integrity portion of FIG. 1.

### DETAILED DESCRIPTION OF THE PREFERRED EMBODIMENTS

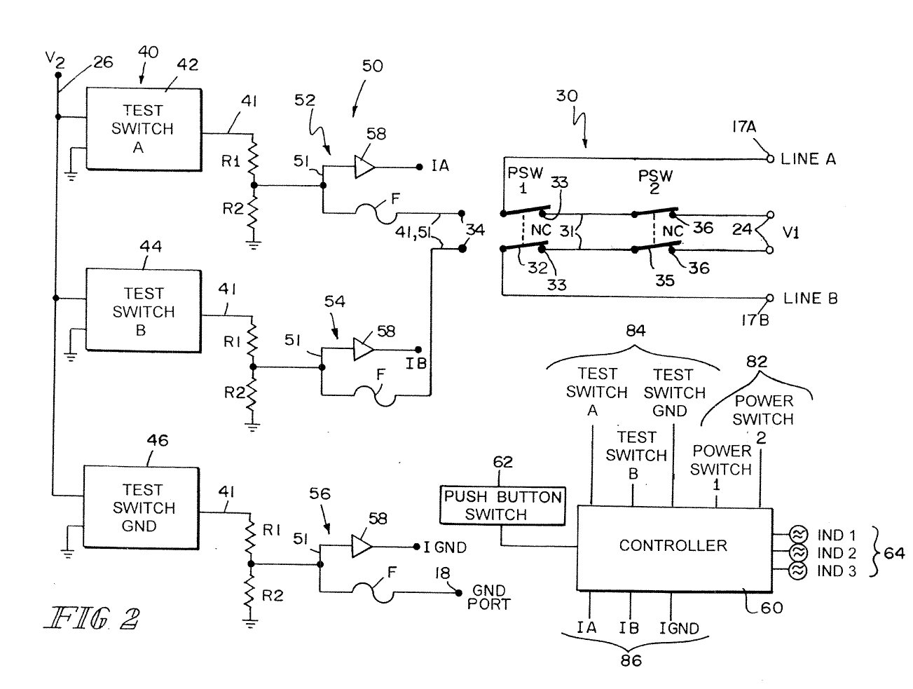

A test device 10 as illustrated in FIG. 2 has a power port 14 connected by cable 12 to a source of power. This may be a standard electrical outlet or any other source of power. A trainline connector 16 is connected by cable 17 to the tester 10. Connector 16 is an approved trainline electrical connector for ECP cars. A ground port 18 is connected by cable 19 to a car ground for example, a car body.

The power port 14 is connected by an on/off switch 20 to a power regulator 22. The power regulator provides two out volts V1 and V2. V1 may be, 15 volt for example, 115 volts which is higher than the 100 volts DC, known as the wake up voltage for ECP systems. This is sufficient voltage to wake up and run tests on the car control device (CCD) on the car. The second voltage V2 may be for example 15 volts DC. This is sufficient voltage to perform the trainline integrity test. The voltage V1 is connected by 24 to a power switch 30. The power switch 30 is controlled by the controller 60 via control 82. The output 31 of the power switch 30 is connected to the trainline port 17. The test voltage V2 is connected by 26 to the test switch 40. The test switch 40 has an output connected to the car ground port 18. It receives a control via 84 from the controller 60. The output 41 of test switch 40 is also connected to the trainline port 17. A sensor 50 is connected by 51 to the trainline port 17 and senses an electrical parameter of the trainline. It is also connected to the controller 60 by 86. A push button 662 is connected to the controller 60. An indicator 64 is connected to the controller 60.

Test device 10 includes a standard ECP tester 70 controlled by the controller 60 via 88 and having a connection 71 to the trainline port 17. Since the ECP tester 70 forms no part of the present invention other than being part of the test device 10 it will not be described in detail. Typical ECP testers may be available from (please list what these testers are and where they are, also verify if the are a part of the controller 60 or they are a separate tester 70).

The single car trainline integrity test is used to detect for example a low impedance path between the two conductors of the trainline power wiring, and to detect a low impedance path between either of the two trainline power conductors and chassis ground. This test is intended to be completed before the newly ECP equipped rail car is connected to a power source. The test is designed to prevent property damage, personal injury, or death, in the event that gross unsafe deficiencies exist in the wiring on the rail car.

Once the electro-pneumatic braking equipment installation has completed, the test apparatus 10 is connected to the trainline power interface of the rail car by connector 16. The test apparatus is connected to line voltage by plug 12, and turned on by switch 20. But before it applies line voltage V1 to the brake equipment, the operator initializes the tester 10 by pressing the push button 62. The circuitry including power switch 30 inhibits the test apparatus from applying line voltage V1 to the rail car, and drives the indicator 64 to indicate the test has started and line voltage V1 is inhibited to the rail car, but the results of the test are yet unknown. Using one or more duel element LEDs, both the red and green elements of each of the LED indicators would be activated, such that they glow orange.

The circuitry tests for low impedance between any of the conductors by applying a test voltage V2 of for example 15 volts DC supply to one conductor, and ground to another. Power and ground to the conductors are switched by test switch 40, which may be a solid-state push-pull driver. A series resistance is implemented to detect the current draw through any path that is formed when the drivers are active. If the current draw indicates an impedance of less than 15,000 ohms for example, a fault is indicated by switching the appropriate LED from orange to red. If the current draw indicates an impedance of greater than 15,000 ohms, the test passes and the LED is switched from orange to green. Execution of the test is controlled by the controller 60 containing an embedded software program.

Troubleshooting when a fault is detected is simplified through the use of the three bicolor LEDs. Each LED is dedicated to representing a low impedance fault condition between any or all of the following: trainline conductor ‘A’ and trainline conductor B′, trainline conductor ‘A’ and chassis ground, and trainline conductor ‘B’ and chassis ground.

At the completion of all testing, if no faults are detected, all of the LEDs are illuminated green, and remain illuminated for approximately two seconds. At the end of the two second period. the line integrity portion of the tester 10 shuts down, and restores the ability to apply nominal voltage from the test apparatus 10 to the electro-pneumatic braking system. If any faults are detected, they are indicated by one or more LEDs illuminated in red. In this case, the faults remain indicated and the ability of the test apparatus to apply nominal voltage to the electro-pneumatic braking system remains inhibited. This is so the operator must acknowledge the faults before continuing by pressing the normally open push button 62. After the button press, the LEDs hold their states for two seconds, and then nominal voltage may be applied to the electro-pneumatic braking system by power switch 30.

The controller 60, which coordinates all functions of the tester 10, contains sufficient EEPROM such that data may be collected for analysis at any time the test apparatus assembly is returned for repair or upgrade. This data includes the total numbers of the following: tests that have been run, tests in which no faults were detected, tests indicating a fault between trainline conductors ‘A’ and ‘B’, tests indicating a fault between trainline conductor ‘A’ and chassis ground, and tests indicating a fault between trainline conductor ‘B’ and chassis ground.

An example of the circuitry for the power switch 30, the test switch 40 and the sensor 50 is illustrated in FIG. 2. The test voltage V1 at line 24 is provided to a first power switch PSW2 which has a switch operator 35 normally closed on contacts 36. This provides a connection 31 to contacts 33 of a power switch PSW1. The operator 32 of PSW1 is normally closed against contacts 23. The operator 32 is connected to line A at 17A and line B at 17B of the trainline connector 16. Thus in the normally closed position of the power switch PSW1 and PSW2, the higher voltage V1 is supplied across line A and line B of the trainline of the car.

As previously described, upon activation of push button switch 62, the controller 60 provides the signals to control the power switches PSW1 and PSW2 to disconnect the voltage V1 from the lines A and B and connect the test circuit to lines A and B. Thus PSW2 is open off its close contacts 36 and operator 32 removes from contacts 33 to contacts 34. This connects the line A and line B to connections 41-51 of the tester switch 40 and the sensor 50. To reduce arcing, PSW2 maybe open first to disconnect the voltage V1 from switches PSW1 before it changes its connection from contacts 33 to contacts 34. When the system has returned from the test to applying of the voltage V1 to the trainline, PSW1 may be closed back on contacts 33 before the connection PSW2 to its contacts 36.

The test switch 40 includes three test switches 42, 44, and 46 each for selectively controlling of the continuity test voltage V2 or ground to the respectively lines A, B and ground ports 17A, 17B and 18 respectfully. The test switches 42, 44, and 46 are under the control of controller 60 and, as discussed above may, be solid-state push-pull drivers. The output of the test switch 42, 44, and 46 are provided by a line 41 to a voltage divider R1 and R2. The center tab of the voltage divider is provided through fuse F to the appropriate terminals 34 for line A and line B and to 18 for the ground port. The resistors R1 and R2 are selected so as to detect a current which indicates an impedance less than or greater 15,000 Ohms.

The sensor 50 includes three operational amplifiers 58 each connected by line 51, fuse F to contacts 34 for line A and B and directly to port 18.

Controller 60 is illustrated as having appropriate outputs to control the power switches PSW1 and PSW2, the test switches 42, 44, and 46 and receive the sensing inputs from operational amplifiers 58. Also for indicators 64.

Although the powers switches PSW1 and PSW2 are illustrated as electromagnetic switches they may solid state switches or any equivalent thereto.

Although the present disclosure has been described and illustrated in detail, it is to be clearly understood that this is done by way of illustration and example only and is not to be taken by way of limitation. The scope of the present disclosure is to be limited only by the terms of the appended claims.

What is claimed:

1. A test device for an electropneumatic brake device on a rail car, the test device comprising:
a trainline connector for connecting the test device to a car trainline to which the electropneumatic brake device is connected;
a power port to receive power for the trainline at a first voltage;
a power switch for selectively connecting the power port to the trainline connector;
a test switch for selectively connecting a test voltage smaller than the first voltage to the trainline connector;
a sensor for sensing an electrical parameter of the trainline; and
a controller for a) initially controlling the power switch to disconnect the power port from the trainline connector, b) subsequently controlling the test switch to connect the test voltage to the trainline connector and c) if the sensor senses an electrical parameter indicative of an acceptable trainline, controlling the test switch to disconnect the test voltage from the trainline connector and controlling the power switch to connect the power port to the trainline connector.

2. The test device of claim 1, wherein the trainline includes two conductors; the test switches includes two conductor test switches each selectively connects a respective conductor to one of the test voltage and ground, as controlled by the controller; and the sensor sensing the electrical parameter of each conductor.

3. The test device of claim 2, including a car ground port; wherein the test switch includes a ground test switch selectively connecting the ground port to one of the test voltage and ground, as controlled by the controller; and wherein the sensor senses the electrical parameter of the ground port.

4. The test device of claim 1, wherein the sensor senses current in the trainline.

5. The test device of claim 4, wherein the controller determines an acceptable trainline if the sensed current is indicative of an impedance above a threshold.

6. The test device of claim 1, wherein the power switch includes a first and second test switches; the first test switch selectively connects the power port to the second test switch when closed; and the second power switch selectively connects one of the test switch and the first power switch to the trainline connector.

7. The test device of claim 6, wherein the controller opens the first power switch before connecting the test switch to the trainline connector using the second power switch.

8. The test device of claim 1, wherein after determining an acceptable trainline, the controller conducts a test of the electropneumatic brake device after controlling the power switch to connect the power port to the trainline connector.

9. The test device of claim 8, wherein after determining an unacceptable trainline, the controller controls the power switch to connect the power port to the trainline connector after an acknowledgement from the operator.

9. The test device of claim 1, including an indicator having three colors and the controller controls the indictor to assume one of the three colors for testing. test passed and test failed.

10. The test device of claim 9, wherein the indicator has two elements of different colors and the controller controls the two elements to produce the three colors.
